(19) United States
(12) Patent Application Publication
(10) Pub. No.: US 2020/0016975 A1
(43) Pub. Date: Jan. 16, 2020

(54) HIGH PRESSURE RESIN FUEL TANK WITH INTERNAL BRACKET/CARRIER SUPPORT STRUCTURE AND EXTERNAL STEEL PIPE REINFORCEMENT

(71) Applicant: HONDA MOTOR CO., LTD., Tokyo (JP)

(72) Inventors: Kevin J. KAASHOEK, Dublin, OH (US); Masaki Wakao, Columbus, OH (US); Hiroshi Kitamura, Dublin, OH (US)

(21) Appl. No.: 16/031,423

(22) Filed: Jul. 10, 2018

(51) Int. Cl. B60K 15/03

(52) U.S. Cl. CPC B60K 15/03177; B60K 2015/03039; B60K 2015/0344; B60K 2015/03493; B60K 2015/0346

(57) ABSTRACT

The present disclosure is directed to a fuel tank with an internal support structure and external reinforcements to minimize deformations due to pressure variations, such as may arise from diurnal temperature variations. Uncontrolled contraction of fuel tanks may result in undesirable reductions of tank volume, and uncontrolled expansion of fuel tanks may result in unwanted collision of fuel tanks with other vehicle components. The fuel tank of the present disclosure may find utility in applications where regular venting of fuel tanks is not practical, such as in hybrid vehicles.

### BACKGROUND

The present disclosure is directed to a fuel tank made of a polymer resin material, as may be used in a hybrid vehicle. In hybrid vehicles, the fuel tank may not be used regularly, and as a result, the fuel tank may be subject to diurnal variations. As temperature rises during the daytime, fuel in the tank becomes pressurized (positive pressure), causing the tank wall to expand. This expansion may result in interaction of fuel tank walls with other vehicle components, which may be undesirable or unsafe. On the other hand, as temperature falls at night, the tank becomes de-pressurized (negative pressure), causing the tank wall to contract. This contraction may result in an undesirable reduction in tank volume and capacity. Accordingly, there is a need to minimize fuel tank expansion and contraction.

### SUMMARY

The following presents a simplified summary of one or more aspects of the present disclosure in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

In some embodiments, the present disclosure is directed to a fuel tank, comprising: a wall defining an internal space; a first support structure in the internal space, the first support structure having a first end attached to the wall and a second end spaced from the wall; and a second support structure abutting an exterior of the wall.

These and other aspects of the invention will become more fully understood upon a review of the detailed description, which follows.

### BRIEF DESCRIPTION OF THE DRAWINGS

FIG. 1A shows a schematic of a cross-sectional view of a fuel tank according to some aspects of the present disclosure.

FIG. 1B shows the fuel tank of FIG. 1A under negative pressure.

FIG. 1C shows the fuel tank of FIG. 1A under positive pressure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

The present disclosure is directed to a fuel tank with an internal support structure and an external reinforcement structure to minimize deformations in the tank walls arising from pressure variations, such as may result from, e.g., diurnal temperature variations. When the tank is under positive pressure (e.g., when the fuel contained within is at high pressure, such as at high temperature), expansion of the tank is limited by the external reinforcement structure. When the tank is under negative pressure (e.g., when the fuel contained within is at low pressure, such as at low temperature), contraction of the tank is limited by the internal support structure. Such fuel tanks may find utility in applications where regular venting of the fuel tank is not practical, for example, in hybrid vehicles.

As used herein, the term “about” is defined to being close to as understood by one of ordinary skill in the art. In one non-limiting embodiment, the term “about” is defined to be within 10%, preferably within 5%, more preferably within 1%, and most preferably within 0.5%.

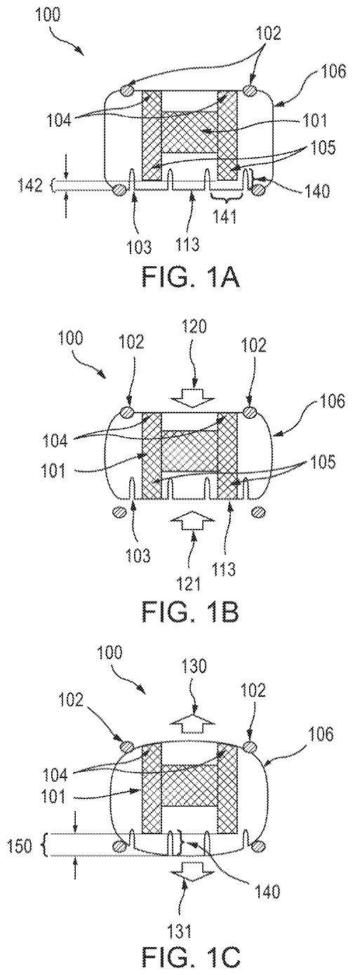

FIG. 1A shows a cross-sectional view of a fuel tank 100, at neutral pressure, having a wall 106 defining an internal space 110 and containing one or more grooves 103. When tank 100 is in use, internal space 110 is configured to contain a liquid or gas, such as a fuel (not shown). Fuel tank 100 also contains, within internal space 110, an internal support structure 101, characterized by one or more first ends 104 attached to wall 106 and one or more second ends 105 spaced from wall 106 by spacing 142. Although internal support structure 101 is depicted as having an H-shape, internal support structure 101 may have any suitable shape. In addition, wall 106 is surrounded by one or more external reinforcements 102.

The one or more first ends 104 of internal support structure 101 may be attached to wall 106 by any suitable means known to those of ordinary skill in the art in order to keep internal support structure 101 attached to wall 106 during fueling, storage, and use of tank 100. Suitable means include, but are not limited to, welding.

The one or more grooves 103 define one or more channels 113 characterized by a width 141, a depth 140, and a length (not shown). The spacing 142 of second end 105 from tank wall 106 may be any distance but is preferably less than or equal to depth 140 of groove 103. The dimensions of width 141, depth 140, and length of channels 113 will depend on the overall size and dimensions of fuel tank 100. In a non-limiting example, depth 140 is less than 10 cm, such as about 6 cm, about 5 cm, about 4 cm, about 3 cm, about 2 cm, about 1 cm, or any integer or subrange in between. In a non-limiting example, the internal support structure 101 may independently be about 10 cm to about 40 cm in any of length or width or height. The height of internal support structure 101 will depend on the height of the fuel tank.

Wall 106 and internal support structure 101 may be made of any materials capable of withstanding temperature and pressure variations during manufacture, assembly, and use of tank 100 and that do not react with liquids or gases which may fill the interior space 110. Suitable materials include polymer resins such as high-density polyethylene (HDPE) or any plastic material that will adhere to an HDPE tank wall during welding; suitable materials can be determined by those of ordinary skill in the art. Examples of suitable materials include, but are not limited to, polypropylene, nylon, isoprene, and polyurethane. Wall 106 may consist of one or more layers, such as an inner layer and an outer layer. In some such aspects, the inner layer may be HDPE. Internal support structure 101 may be made of the same or different materials than wall 106. In addition, internal support structure 101 may be a different thickness than wall 106. For example, internal support structure may be thinner than wall 106 or thinner than an inner layer of wall 106. Wall 106 and internal support structure 101 may be manufactured by any suitable means known to those of ordinary skill in the art, including, but not limited to, blow molding, injection molding, casting, etc.

When tank 100 is under negative pressure, i.e., the tank wall 106 has a tendency to contract in directions 120 and 121, contraction is limited by internal support structure 101. As shown in FIG. 1B, internal support structure 101 may be welded at one or more first ends 104 to wall 106 such that, when fuel tank 100 is under negative pressure, the one or more second ends 105 are received in the one or more channels 113 defined by the one or more grooves 103. In the aspect shown, the grooves 103 in wall 106 define two channels 113 that receive second ends 105 of internal support structure 101, eliminating spacing 142. In addition, external reinforcements 102 may serve to limit or direct regional bulging of wall 106 upon overall contraction of fuel tank 100. During the forming process, the second end 105 suitably does not bond to the tank wall. Suitable materials for the second end include polyoxymethylene (POM) or any material that will not adhere to the HDPE tank wall during forming; such materials can be determined by those of ordinary skill in the art.

When tank 100 is under positive pressure, i.e., the tank wall 106 has a tendency to expand in directions 130 and 131, expansion is limited by the one or more external reinforcements 102. As shown in FIG. 1C, wall 106 bulges outward in directions 130 and 131, but the bulging is blocked by the one or more external reinforcements 102. As a result, second end 105 becomes spaced from wall 106 by gap 150, where gap 150 is greater than spacing 142 but not greater than depth 140. Depth 140 is set such that second end 105 does not become spaced from wall 106 by a distance greater than the depth 140 in the worst case deformation. In addition, under positive pressure, welds connecting first ends 104 to wall 106 are not under stress. The one or more external reinforcements 102 may be made of any material capable of withstanding the forces of expansion upon wall 106. Suitable materials include, but are not limited to, steel and stainless steel, such as steel piping or stainless steel piping, STAM steel grade, aluminum, and fiber-reinforced plastic. The material is suitably selected based on the allowable deformation desired in the tank wall, which can be determined by those of ordinary skill in the art.

As will be known to those of ordinary skill in the art, ranges of pressure variation for tank 100 will depend on several factors, including, but not limited to, tank dimensions, temperature variations, climate, vehicle, frequency and conditions of use (of the vehicle or more specifically of the fuel tank, in the case of a hybrid vehicle). Determination these factors and of pressure variation ranges is within the level of ordinary skill in the art. The pressures are higher in magnitude in both the positive and negative directions than conventional fuel tanks.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

The examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, dimensions, etc.) but some experimental errors and deviations should be accounted for.

Moreover, all references throughout this application, for example patent documents including issued or granted patents or equivalents; patent application publications; and non-patent literature documents or other source material; are hereby incorporated by reference herein in their entireties, as though individually incorporated by reference.

What is claimed is:

1. A fuel tank, comprising:
a wall defining an internal space;
a first support structure in the internal space, the first support structure having a first end attached to the wall and a second end spaced from the wall; and
a second support structure abutting an exterior of the wall.

2. The fuel tank of claim 1, wherein, the second support structure is positioned so as to limit expansion of the wall of the fuel tank when the fuel tank is under a positive pressure.

3. The fuel tank of claim 1, wherein the wall of the fuel tank adjacent the second end of first support structure includes one or more grooves, the one or more grooves defining a channel within which the second end of the first support structure is received.

4. The fuel tank of claim 3, wherein the wall of the fuel tank adjacent the second end of the first support structure includes two channels.

5. The fuel tank of claim 3, wherein the channel is defined by a length, a width, and a depth, and wherein the depth of the channel is less than or equal to about 6 cm.

6. The fuel tank of claim 1, wherein the first support structure is comprised of a polymer resin material.

7. The fuel tank of claim 6, wherein the polymer is high-density polyethylene (HDPE).

8. The fuel tank of claim 1, wherein the fuel tank wall comprises at least an inner layer and an outer layer, and at least the inner layer is comprised of a polymer resin material.

9. The fuel tank of claim 8, wherein at least the inner layer is comprised of high-density polyethylene (HDPE).

10. The fuel tank of claim 9, wherein the first support structure is comprised of a polymer resin material.

11. The fuel tank of claim 10, wherein the first support structure is comprised of HDPE.

12. The fuel tank of claim 1, wherein the second support structure is comprised of steel.
